(19) United States
(12) Patent Application Publication
(10) Pub. No.: US 2014/0152901 A1
(43) Pub. Date: Jun. 5, 2014

(54) CONTROL SYSTEM FOR VIDEO DEVICE AND VIDEO DEVICE

(71) Applicant: Funai Electric Co., Ltd., Osaka (JP)

(72) Inventors: Shusuke NARITA, Daito-shi (JP); Yoshitaka KATAOKA, Daito-shi (JP)

(73) Assignee: Funai Electric Co., Ltd., Osaka (JP)

(21) Appl. No.: 14/089,889

(22) Filed: Nov. 26, 2013

(30) Foreign Application Priority Data
Dec. 3, 2012 (JP) 2012-264174

(51) Int. Cl. H04N 5/44

(52) U.S. Cl. CPC H04N 5/4403
USPC 348/734

(57) ABSTRACT

A control system controls a video device without using any dedicated remote control device based on detection signals of the device including a detector. The control system includes a mobile terminal including at least one sensor unit and a wireless LAN communication unit to send terminal-side sensor unit information pertaining to the sensor unit and terminal-side detection signals detected by the sensor unit at the time of a specified control action on a set top box. The set top box includes a control unit and a wireless LAN communication unit to receive the terminal-side sensor unit information and the terminal-side detection signals from the mobile terminal. The control unit recognizes the sensor unit from the terminal-side sensor unit information and also performs actuation control corresponding to a specified control action on the set top box based on the terminal-side detection signals of the recognized sensor unit.

### BACKGROUND OF THE INVENTION

1. Field of the Invention

The present invention relates to a control system for video devices and a video device and particularly to a control system for video devices that can be controlled by a mobile terminal, as well as such a video device.

2. Description of the Related Art

Conventionally, control systems for video devices that can be controlled by a remote control or other device have been known (see, for example, Japanese Patent Application Laid-Open Publication No. 2010-128874).

Japanese Patent Application Laid-Open Publication No. 2010-128874 discloses a projector equipped with a remote control and a projector main body (video device). The remote control includes a tilt information generator (terminal-side detector) that detects tilt and generates tilt information (terminal-side detection signals); a control information generator that, based on the tilt information, generates control information indicating the content of control depending on the tilt; and a transmitter for transmitting tilt information and control information to the projector main body. Furthermore, the projector main body includes a corrector that corrects distortion of images based on the tilt information and an image generator that performs image processing based on the control information. Moreover, this projector is constituted such that when the remote control is attached to the projector main body, the remote control sends tilt information to the projector main body, thereby the corrector corrects the distortion of images based on the tilt information. This projector is constituted such that when the remote control is removed from the projector main body, the remote control sends control information that is generated based on the tilt information to the projector main body, whereby the image generator performs image processing such as image enlargement and shrinking based on the control information. Although not clearly stated in Japanese Patent Application Laid-Open Publication No. 2010-128874, the remote control is considered to be a device used exclusively for the projector.

However, with the projector described in Japanese Patent Application Laid-Open Publication No. 2010-128874, there is a problem in that no device other than a dedicated remote control can be used.

### SUMMARY OF THE INVENTION

Preferred embodiments of the present invention provide a control system for video devices in which it is possible to control video devices based on detection signals of devices including detectors without using any dedicated remote control device, as well as such a video device.

A control system for a video device according to a preferred embodiment of the present invention includes a mobile terminal which includes at least one terminal-side detector and a terminal-side communication unit that sends terminal-side detector information pertaining to the terminal-side detector and a terminal-side detection signal detected by the terminal-side detector at the time of a specified control action; and a video device which includes a control unit and a device-side communication unit that receives the terminal-side detector information and the terminal-side detection signal from the mobile terminal, wherein the control unit of the video device is constituted and programmed so as to recognize the terminal-side detector from the terminal-side detector information and also perform actuation control corresponding to the specified control action on the video device based on the terminal-side detection signal of the recognized terminal-side detector.

As was described above, with the control system for a video device according to a preferred embodiment of the present invention, the control unit of the video device is programmed to recognize the terminal-side detector from the terminal-side detector information and also is programmed to perform actuation control corresponding to the specified control action on the video device based on the terminal-side detection signal of the recognized terminal-side detector, such that the control unit of the video device is programmed to recognize in advance the terminal-side detection signal of the terminal-side detector in the mobile terminal, such that the content of the terminal-side detection signal sent from the mobile terminal to the control unit of the video device is correctly identified, and the actuation control corresponding to the specified control action on the video device is performed. This makes it possible to control the video device based on the terminal-side detection signal of the mobile terminal including the terminal-side detector without the use of any dedicated remote control device.

In the control system for a video device according to a preferred embodiment of the present invention, it is preferable that the terminal-side detector be provided in order to satisfy specified functions when the mobile terminal is used alone, and that the control unit of the video device be constituted and programmed so as to adapt the terminal-side detector that is used to satisfy the specified functions of the mobile terminal for the actuation control corresponding to the specified control action on the video device. By having such a constitution, it is possible to add the function of performing the specified control action on the video device to the mobile terminal that can also be used alone, such that the control system for a video device according to a preferred embodiment of the present invention can be constructed easily using a universal (general-use) mobile terminal.

In this case, it is preferable that the mobile terminal include, as the terminal-side detector that performs the specified functions of a mobile terminal, at least one of an image-capture unit that captures images, a gyro sensor that detects the attitude of the mobile terminal, and a microphone that enables conducting of conversations, and that the control unit of the video device be constituted and programmed so as to use at least one of the image-capture unit, the gyro sensor, and the microphone of the mobile terminal to perform actuation control corresponding to the specified control action on the video device. With such a constitution, it is possible to add the function of performing the specified control action on the video device to the mobile terminal that can also be used alone with the use of at least one of the image-capture unit, gyro sensor, or microphone.

In the control system for a video device according to a preferred embodiment of the present invention, it is preferable that the mobile terminal include a plurality of the terminal-side detectors, and that the control unit of the video device be constituted and programmed so as to recognize terminal-side detectors required for the control of the video device from among the plurality of terminal-side detectors based on the terminal-side detector information and also so as to exert control to have the device-side communication unit send a signal which causes the terminal-side communication unit to send the terminal-side detection signals of those of the terminal-side detectors required for the control of the video device but causes the terminal-side communication unit not to send the terminal-side detection signals of those of the terminal-side detectors not required for the control of the video device. With such a constitution, only those terminal-side detection signals required for the control of the video device will be sent from the mobile terminal to the video device, so it is possible to keep the amount of communications traffic between the mobile terminal and the video device from increasing.

In this case, it is preferable that the control unit of the video device be constituted and programmed so as to exert control to have the device-side communication unit send a signal to the effect of disabling the operation of the terminal-side detectors not required for the control of the video device. If such a constitution is adopted, because those terminal-side detectors that are not required for the control of the video device are disabled, it is possible to halt the operation of unnecessary terminal-side detectors. Consequently, in battery-driven mobile terminals where increased power consumption is a major problem, an increase in the power consumption is reliably prevented.

In the control system for a video device according to a preferred embodiment of the present invention, it is preferable that the mobile terminal include a plurality of the terminal-side detectors, and that the terminal-side detector information pertaining to the plurality of terminal-side detectors include information in the form of a list of the plurality of terminal-side detectors. Having such a constitution makes it possible for the control unit of the video device to easily recognize in advance the terminal-side detectors based on the terminal-side detector information which includes information in the form of the list of the plurality of terminal-side detectors.

In the control system for a video device according to a preferred embodiment of the present invention, it is preferable that the video device also include at least one device-side detector, and that the control unit of the video device be constituted so as to create integrated detector information by integrating device-side detector information pertaining to the device-side detector and the terminal-side detector information, recognize the device-side detector and the terminal-side detector(s) from the integrated detector information thus created, and perform actuation control corresponding to the specified control action on the video device based on a device-side detection signal detected by the recognized device-side detector and/or the terminal-side detection signals of the recognized terminal-side detector(s). By having such a constitution, the control unit of the video device recognizes not only the terminal-side detector(s) of the mobile terminal, but also the device-side detector of the video device, so actuation control can be performed on the video device based on more detection signals, including not only the terminal-side detection signals but also the device-side detection signals, than in the case when only the terminal-side detector(s) of the mobile terminal are recognized.

In this case, it is preferable that the control unit of the video device be constituted and programmed such that if the control unit determines from the integrated detector information that there is commonality between the type of the device-side detector and the type of the terminal-side detector(s), the control unit performs actuation control corresponding to the specified control action on the video device based on both the device-side detection signals of the device-side detector and the terminal-side detection signals of the terminal-side detector(s). With such a constitution, the user is able to perform specified control actions on the video device using both the mobile terminal and the video device, so the user can use either the mobile terminal or the video device, whichever is easier to control, to perform specified control actions on the video device. Consequently, the control system for a video device according to a preferred embodiment of the present invention is more convenient.

In the control system for a video device in which integrated detector information is created, it is preferable that the control unit of the video device be constituted and programmed such that if the control unit determines from the integrated detector information that there is commonality between the type of the device-side detector and the type of the terminal-side detector(s), it performs actuation control corresponding to the specified control action on the video device based on either the device-side detection signals of the device-side detector or the terminal-side detection signals of the terminal-side detector(s), whichever is selected by the user. With such a constitution, the detection signals of the detector not selected by the user are not used, so it is possible to prevent output of detection signals from the detector not selected by the user. This makes it possible to prevent control actions not intended by the user from being performed on the video device.

In the control system for a video device in which integrated detector information is created, it is preferable that the video device also include a recording unit capable of recording the integrated detector information, and that the control unit of the video device be constituted and programmed so as to be able to maintain the created integrated detector information without deleting it from the recording unit when the video device and the mobile terminal are disconnected. With such a constitution, there is no need to recreate anew the integrated detector information when the video device and the mobile terminal are reconnected, so it is possible to start operation of the control system more quickly.

The video device according to another preferred embodiment of the present invention is a video device which can be controlled by a mobile terminal, including a device-side communication unit that receives from the mobile terminal, terminal-side detector information pertaining to at least one terminal-side detector possessed by the mobile terminal and terminal-side detection signals detected by the terminal-side detector at the time of a specified control action on the video device; and a control unit that is programmed to recognize the terminal-side detector from the terminal-side detector information and also is programmed to perform actuation control corresponding to the specified control action on the video device based on the terminal-side detection signals of the recognized terminal-side detector.

As was described above, with the video device according to a preferred embodiment, the control unit is programmed to recognize the terminal-side detector from the terminal-side detector information and also performs actuation control corresponding to the specified control action on the video device based on the terminal-side detection signals of the recognized terminal-side detector, such that the control unit recognizes in advance the terminal-side detection signals of the terminal-side detector in the mobile terminal. Therefore, it is possible to correctly identify the content of the terminal-side detection signals sent from the mobile terminal to the control unit and to perform the actuation control corresponding to the specified control action on the video device. This makes it possible to control the video device without the use of any dedicated remote control device based on the terminal-side detection signals of the mobile terminal having a terminal-side detector.

With various preferred embodiments of the present invention, as was described above, it is possible to control video devices based on the terminal-side detection signals of mobile terminals having terminal-side detectors without using any dedicated remote control device.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an overall view showing the control system according to a first preferred embodiment of the present invention.

FIG. 2 is a block diagram showing the control structure of the control system according to the first preferred embodiment of the present invention.

FIG. 3 is a diagram showing the STB-side sensor unit information of the control system according to the first preferred embodiment of the present invention.

FIG. 4 is a diagram showing the terminal-side sensor unit information of the control system according to the first preferred embodiment of the present invention.

FIG. 5 is a diagram showing the integrated sensor unit information of the control system according to the first preferred embodiment of the present invention.

FIG. 6 is a diagram showing the flow of processing of the control unit of the STB and the control unit of the mobile terminal when the STB and the mobile terminal are connected in the control system according to the first preferred embodiment of the present invention.

FIG. 7 is a diagram showing the flow of processing of the control unit of the STB in the process of rewriting the sensor unit information when the STB and the mobile terminal are connected in the control system according to the first preferred embodiment of the present invention.

FIG. 8 is a diagram showing the flow of processing of the control unit of the STB and the control unit of the mobile terminal at the time of a control action of the STB in the control system according to the first preferred embodiment of the present invention.

FIG. 9 is a diagram showing the flow of processing of the control unit of the STB in the process of rewriting the sensor unit information when the STB and the mobile terminal are cut off in the control system according to the first preferred embodiment of the present invention.

FIG. 10 is a diagram showing the flow of processing of the control unit of the STB in the process of rewriting the sensor unit information when the STB and the mobile terminal are connected in the control system according to a second preferred embodiment of the present invention.

FIG. 11 is a diagram showing a rewrite selection screen at the time of connection in the control system according to the second preferred embodiment of the present invention.

FIG. 12 is a diagram showing the flow of processing of the control unit of the STB in the process of rewriting the sensor unit information when the STB and the mobile terminal are cut off in the control system according to the second preferred embodiment of the present invention.

FIG. 13 is a diagram showing a rewrite selection screen at the time of cutoff in the control system according to the second preferred embodiment of the present invention.

FIG. 14 is a diagram showing the flow of processing of the control unit of the STB in the process of rewriting the sensor unit information when the STB and the mobile terminal are connected in the control system according to a third preferred embodiment of the present invention.

FIG. 15 is a diagram showing a sensor unit selection screen at the time of connection in the control system according to the third preferred embodiment of the present invention.

FIG. 16 is a diagram showing integrated sensor unit information when the camera of the STB is selected in the control system according to the third preferred embodiment of the present invention.

FIG. 17 is a diagram showing integrated sensor unit information when the camera of the mobile terminal is selected in the control system according to the third preferred embodiment of the present invention.

### DETAILED DESCRIPTION OF THE PREFERRED EMBODIMENTS

Preferred embodiments of the present invention will be described below based on the drawings.

### First Preferred Embodiment

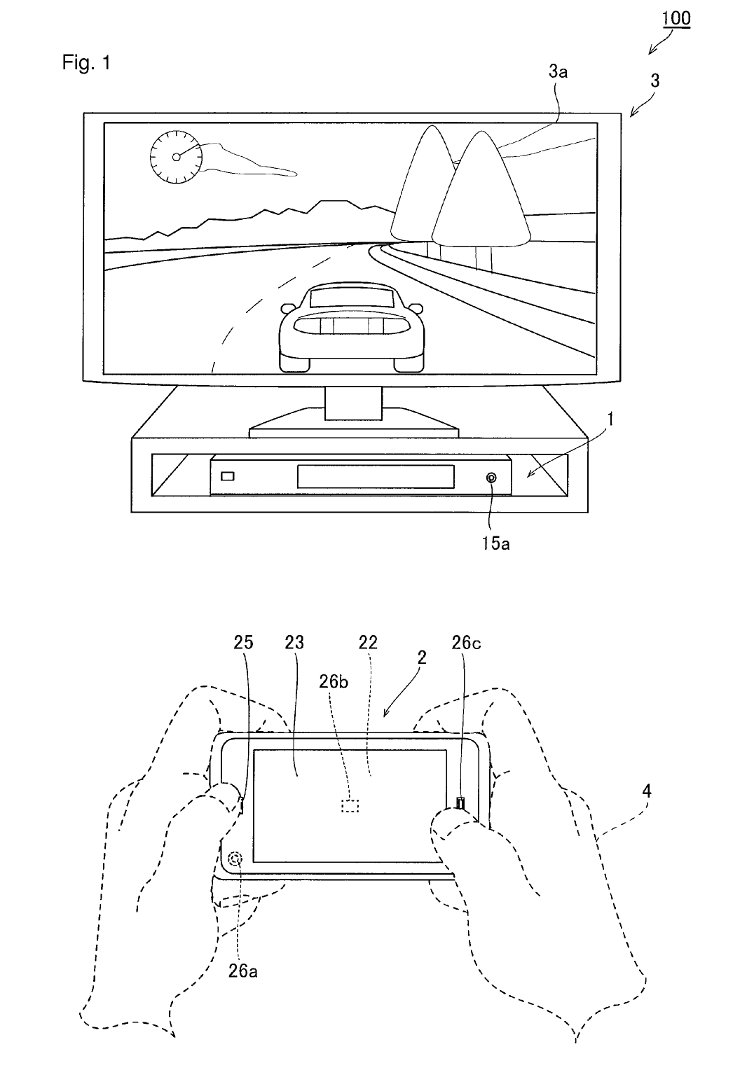

First, the structure of the control system 100 according to a first preferred embodiment of the present invention will be described with reference to FIGS. 1 through 5. Note that the control system 100 is one non-limiting example of “the control system for a video device” of a preferred embodiment of the present invention.

As is shown in FIG. 1, the control system 100 according to the first preferred embodiment of the present invention includes a set-top box (STB) 1 and a mobile terminal 2 that has a device control application capable of controlling the STB 1. The STB 1 is connected to a display device 3 capable of providing video and audio output. Furthermore, while the STB 1 and the display device 3 are installed in a fixed manner such as inside a room, the mobile terminal 2 is constituted so as to be portable while being held in the hands of a user 4. Moreover, the mobile terminal 2 has a battery (not shown) and is constituted such that it can be operated while being carried around by the user 4. Note that the STB 1 is one non-limiting example of a “video device”.

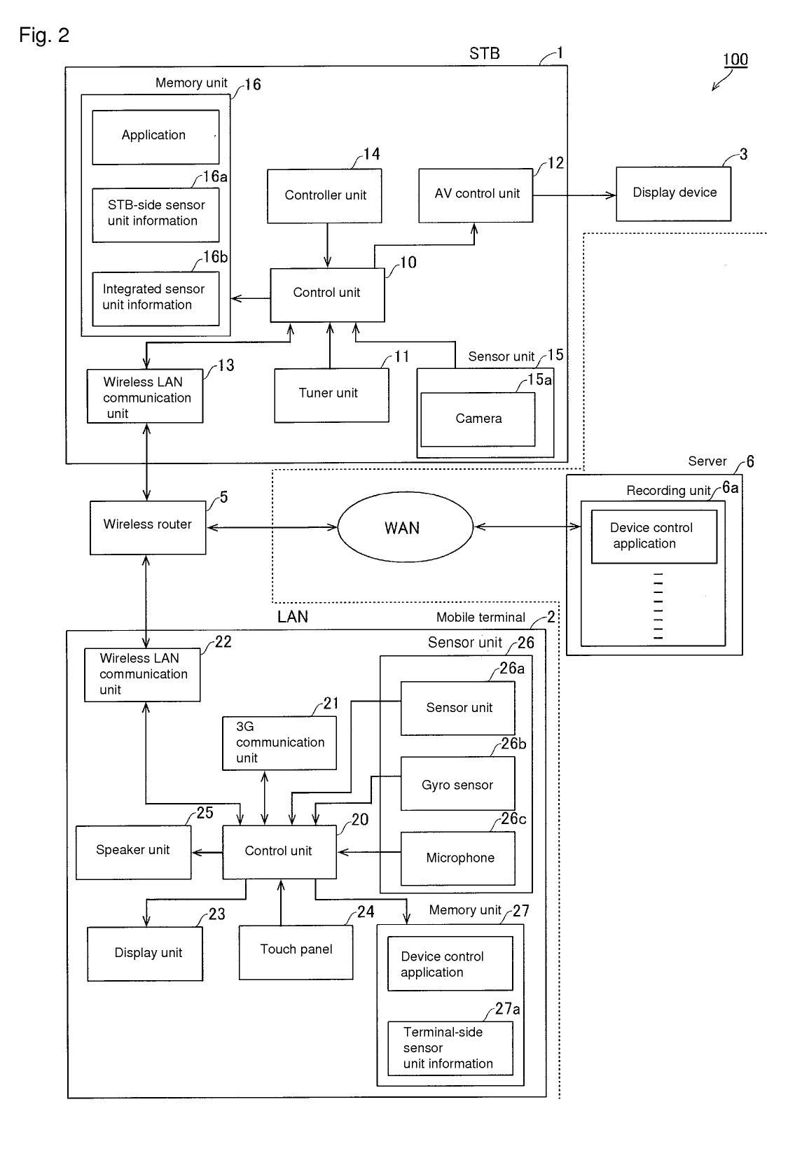

As is shown in FIG. 2, the STB 1 includes a control unit 10, a tuner unit 11, an AV control unit 12, a wireless LAN communication unit 13, a controller unit 14, a sensor unit 15, and a memory unit 16. Note that the wireless LAN communication unit 13, sensor unit 15, and memory unit 16 are each non-limiting examples of a “device-side communication unit,” “device-side detector,” and “recording unit,” respectively.

The control unit 10 preferably is a CPU and is programmed to execute an operating system (OS) and applications stored in the memory unit 16 to perform actuation control of the STB 1. The tuner unit 11 has the function of receiving television broadcasts, cable broadcasts, satellite broadcasts, and the like. The AV control unit 12 has the function of sending the video and audio of television broadcasts and the like to the display device 3.

Note that the display device 3 (see FIG. 1) is currently displaying a game screen 3a (see FIG. 1) of a car racing game. The wireless LAN communication unit 13 is constituted such that it can connect wirelessly to a wireless router 5. The controller unit 14 is preferably provided with a touch panel, an infrared remote control, and infrared receiver and other interfaces (not shown), being provided for the user 4 (see FIG. 1) to operate the STB 1.

The sensor unit 15 has the function of detecting specified information and converting it to electrical detection signals. Note that the STB 1 includes, as the sensor unit 15, a camera 15a having the image-capture function of detecting (receiving) the light around the STB 1 and converting it into an image signal. Note that the image signal from the camera 15a is one non-limiting example of a “device-side detection signal”.

The memory unit 16 is used as work memory which temporarily stores parameters under control used at the time of execution of the OS and the like. In addition, the OS and a plurality of applications are stored in the memory unit 16. Furthermore, the memory unit 16 records either STB-side sensor unit information 16a or integrated sensor unit information 16b as sensor unit information. Note that the STB-side sensor unit information 16a and the integrated sensor unit information 16b are each non-limiting examples of a “device-side detector information” and “integrated detector information,” respectively.

The mobile terminal 2 preferably includes a control unit 20, a 3G communication unit 21, a wireless LAN communication unit 22, a display unit 23, a touch panel 24, a speaker unit 25, sensor units 26, and a memory unit 27 as shown in FIG. 2. Note that the wireless LAN communication unit 22 and the sensor units 26 are each non-limiting examples of a “terminal-side communication unit” and “terminal-side detector,” respectively.

The control unit 20 preferably is a CPU and is programmed to execute an operating system (OS) and applications stored in the memory unit 27 to perform actuation control of the mobile terminal 2. The 3G communication unit 21 is constituted such that conversations with other mobile terminals and the like are possible through the use of 3G circuits. The wireless LAN communication unit 22 is constituted so as to be capable of wireless connections with the wireless router 5. The display unit 23 is constituted so as to be able to display controller screens and other video images. The touch panel 24 is disposed on the display unit 23 and is constituted so as to allow the user 4 (see FIG. 1) to operate the mobile terminal 2 by the user pressing keys or the like based on controller screens displayed on the display unit 23. The speaker unit 25 has the function of outputting audio at the time of voice conversations and the like.

Moreover, the mobile terminal 2 includes, as the sensor units 26, a camera 26a having the image-capture function of detecting (receiving) the light around the mobile terminal 2 and converting it into an image signal, along with a gyro sensor 26b having the function of detecting the attitude of the mobile terminal 2 and converting it into a tilt signal, and a microphone 26c having the function of detecting (recording) sound around the mobile terminal 2 and converting it into an audio signal. The mobile terminal 2 includes, as its sensor unit 26, the camera 26a that is preferably the same type as the camera 15a of the STB 1. Note that the camera 26a is one non-limiting example of a “image-capture unit”, and also that the image signals from the camera 26a, the tilt signals from the gyro sensor 26b, and the audio signals from the microphone 26c are non-limiting examples of “terminal-side detection signals”.

In addition, the sensor units 26 are provided in order to satisfy specified functions when the mobile terminal 2 is used alone. In concrete terms, the mobile terminal 2 has functions including that of displaying images captured based on image signals from the camera 26a as wallpaper on the display unit 23. Furthermore, the mobile terminal 2 has functions including that of switching the images displayed on the display unit 23 in the up/down direction or the left/right direction based on tilt signals from the gyro sensor 26b. Moreover, the mobile terminal 2 has the function of conducting conversations via the 3G communication unit 21 based on audio signals from the microphone 26c.

The memory unit 27 is used as work memory which temporarily stores parameters under control used at the time of execution of the OS and the like. In addition, the OS and a plurality of applications, as well as a device control application and terminal-side sensor unit information 27a, are stored in the memory unit 27. This device control application is an application that controls the STB 1 based on image signals from the camera 26a, tilt signals from the gyro sensor 26b, and audio signals from the microphone 26c. Note that the terminal-side sensor unit information 27a is one non-limiting example of a “terminal-side detector information”.

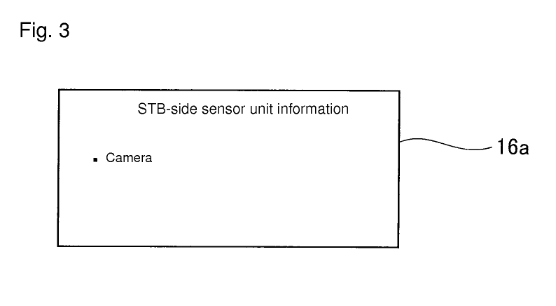

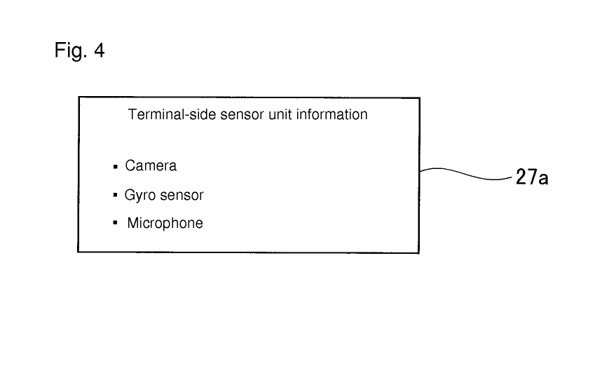

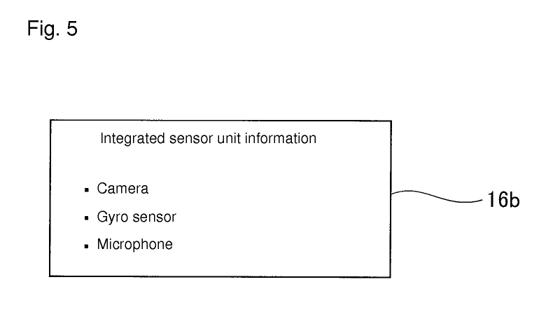

Furthermore, the STB-side sensor unit information 16a stored in the memory unit 16 of the STB 1 has the record of the fact that the STB 1 (see FIG. 2) includes a camera 15a (see FIG. 2) as shown in FIG. 3. Moreover, the terminal-side sensor unit information 27a stored in the memory unit 27 of the mobile terminal 2 has the record in list form of the fact that the mobile terminal 2 (see FIG. 2) includes a camera 26a (see FIG. 2), a gyro sensor 26b (see FIG. 2), and a microphone 26c (see FIG. 2) as shown in FIG. 4. In addition, as is shown in FIG. 5, the integrated sensor unit information 16b has the record in list form of the fact of including a camera, a gyro sensor, and a microphone as the sensor units that can be used for the control of the STB 1 as a result of the sensor unit 15 (see FIG. 2) of the STB 1 and the sensor units 26 (see FIG. 2) of the mobile terminal 2 being integrated.

Furthermore, the wireless LAN communication unit 13 of the STB 1 and the wireless LAN communication unit 22 of the mobile terminal 2 are both included within the local area network (LAN) of the wireless router 5 as shown in FIG. 2. Consequently, the constitution is such that the wireless LAN communication unit 13 and the wireless LAN communication unit 22 of the mobile terminal 2 are able to exchange signals and information. The wireless LAN communication unit 22 is constituted so as to be able to send to the STB 1 terminal-side sensor unit information 27a, image signals from the camera 26a, tilt signals from the gyro sensor 26b, and audio signals from the microphone 26c. Moreover, the wireless LAN communication unit 13 is constituted so as to be able to receive the terminal-side sensor unit information 27a, the image signals, the tilt signals, and the audio signals from the mobile terminal 2.

In addition, the wireless router 5 is connected to a server 6 via a wide area network (WAN). The device control application, applications that are operated using the sensor units 15 and 26, and so forth, are stored in a recording unit 6a of the server 6. Furthermore, the STB 1 is constituted to acquire applications from the server 6 and store them in the memory unit 16 and is also able to execute the applications thus acquired. Moreover, the mobile terminal 2 is constituted so as to acquire at least the device control application and the like from the server 6 and store this in the memory unit 27 and also so as to be able to execute the device control application and the like thus acquired. Note that the device control application and other applications may also be stored in advance in the memory unit 16 of the STB 1 or in the memory unit 27 of the mobile terminal 2.

Here, in the first preferred embodiment, based on the device control application being executed on the mobile terminal 2, the control unit 10 of the STB 1 recognizes from the terminal-side sensor unit information 27a that the mobile terminal 2 includes the camera 26a, gyro sensor 26b, and microphone 26c as the sensor units 26 of the mobile terminal 2. In addition, the control unit 10 is constituted so as to adopt the sensor units 26 of the mobile terminal 2, thus performing actuation control corresponding to specified control actions upon the application executed on the STB 1 based on the image signals from the recognized camera 26a, the tilt signals from the recognized gyro sensor 26b, and the audio signals from the recognized microphone 26c. The constitution is such that this makes it possible to complement the STB 1 with the various functions of the camera, gyro sensor, and microphone by adapting the sensor units 26 of the mobile terminal 2 without providing the STB 1 with any camera, gyro sensor, or microphone. Note that concrete control processing will be described later.

Next, with reference to FIGS. 2 through 7, a description will be given of the flow of control processing of the STB 1 and the flow of control processing of the mobile terminal 2 when the STB 1 and the mobile terminal 2 are connected.

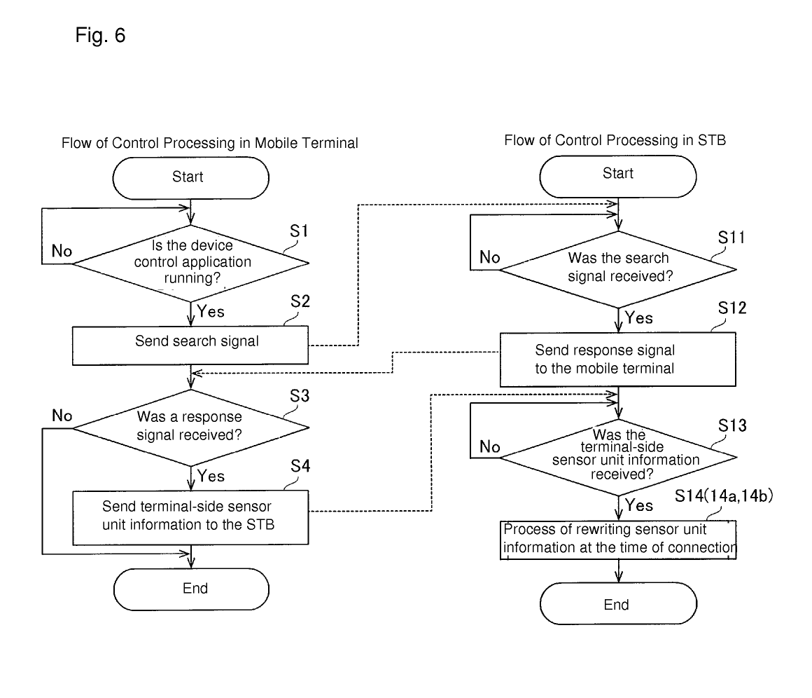

First, the OS or an application is executed in the STB (see FIG. 2). Furthermore, while the memory unit 16 (see FIG. 2) of the STB 1 has the record of the STB-side sensor unit information 16a (see FIG. 3), the integrated sensor unit information 16b (see FIG. 5) is not stored. Starting from this state, as is shown in FIG. 6, the control unit 20 (see FIG. 2) of the mobile terminal 2 (see FIG. 2) determines in Step S1 whether or not the device control application has been started up on the mobile terminal 2, and this determination is repeated until the device control application is determined to have been started up.

When the device control application is determined to have been started up, in Step S2, the control unit 20 sends from the wireless LAN communication unit 22 (see FIG. 2) to the STB 1 a search signal for searching for devices capable of communication contained within the local area network (LAN) of the wireless router 5 (see FIG. 2).

Moreover, in Step S11 on the side of the STB 1, the control unit 10 (see FIG. 2) of the STB 1 determines whether or not the search signal has been received, and this determination is repeated until the search signal is determined to have been received. When the search signal is determined to have been received, in Step S12, the control unit 10 sends from the wireless LAN communication unit 13 (see FIG. 2) to the mobile terminal 2 a response signal to the search signal.

Then, in Step S3 on the side of the mobile terminal 2, the control unit 20 determines whether or not the response signal from the STB 1 has been received, and this determination is repeated until the response signal is determined to have been received. If no response signal is determined to have been received, the control unit 20 determines that there is no device that can be controlled with the device control application, and the flow of control processing of the mobile terminal 2 at the time of connection is terminated.

In addition, if it is determined in Step S3 that the response signal has been received, then in Step S4 on the side of the mobile terminal 2, the control unit 20 determines that the state of connection between the STB 1 and the mobile terminal 2 is established, and the terminal-side sensor unit information 27a (see FIG. 4) of the memory unit 27 (see FIG. 2) is sent to the STB 1. This completes the flow of control processing of the mobile terminal 2 at the time of connection.

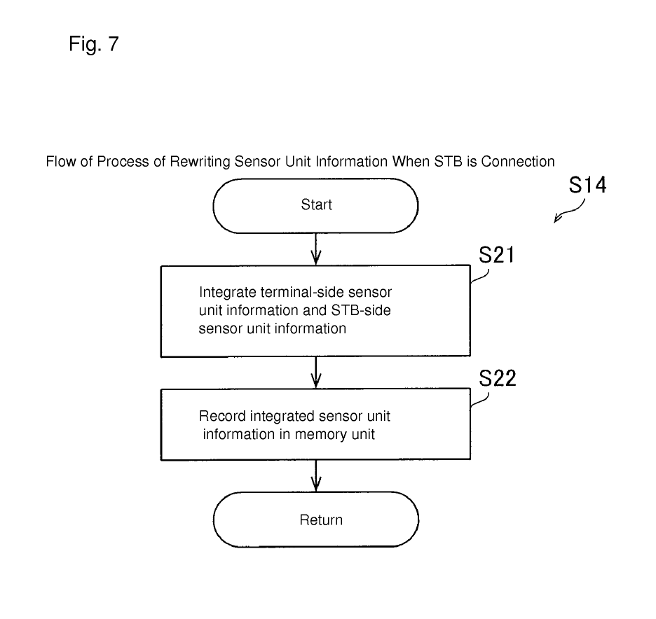

Furthermore, in Step S13 on the side of the STB 1, the control unit 10 determines whether or not the terminal-side sensor unit information 27a has been received from the mobile terminal 2, and this determination is repeated until the terminal-side sensor unit information 27a is determined to have been received. When the terminal-side sensor unit information 27a is determined to have been received, the process moves to Step S14. In Step S14, the control unit 10 performs the process of rewriting the sensor unit information at the time of connection shown in FIG. 7.

In the process of rewriting the sensor unit information in this Step S14, first, as is shown in FIG. 7, in Step S21, the control unit 10 integrates the terminal-side sensor unit information 27a received from the mobile terminal 2 and the STB-side sensor unit information 16a of the memory unit 16 to create the integrated sensor unit information 16b (see FIG. 5). In concrete terms, it is recognized from the terminal-side sensor unit information 27a that the mobile terminal 2 includes the camera 26a, gyro sensor 26b, and microphone 26c, and it is also recognized from the STB-side sensor unit information 16a that the STB 1 includes the camera 15a. Then, the sensor unit 15 of the STB 1 and the sensor units 26 of the mobile terminal 2 are integrated to create the integrated sensor unit information 16b which records the fact that there are cameras, a gyro sensor, and a microphone as the sensor units that can be used in control actions on the STB 1.

Thereafter, in Step S22, the integrated sensor unit information 16b thus created is recorded in the memory unit 16 by the control unit 10. Then, the process of rewriting the sensor unit information (Step S14) at the time of connection is terminated, and the flow of control processing of the STB 1 (see FIG. 6) at the time of connection is terminated.

Next, with reference to FIGS. 1 through 3, 5, 8, and 9, a description will be given of the flow of control processing of the STB 1 and the flow of control processing of the mobile terminal 2 at the time of control actions.

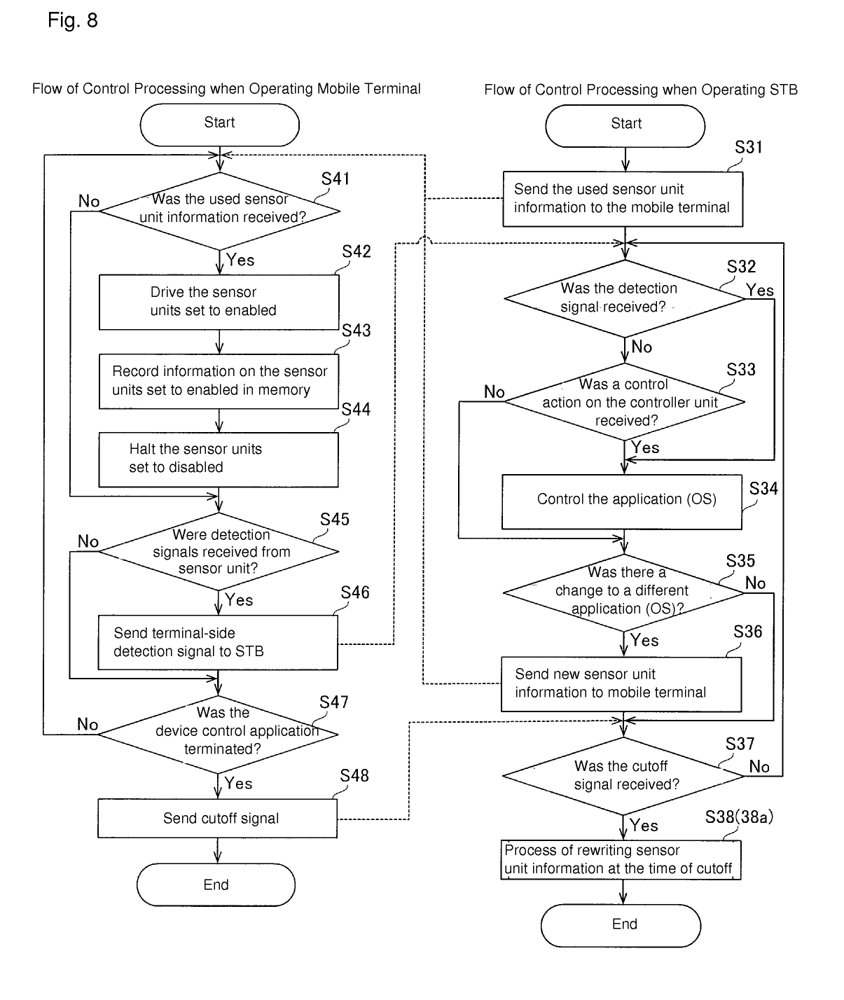

First, as is shown in FIG. 8, in Step S31, the control unit 10 (see FIG. 2) of the STB 1 (see FIG. 2) recognizes based on the integrated sensor unit information 16b (see FIG. 5) which sensor units are being used by the OS or application currently being executed on the STB 1. Then, the used sensor unit information related to the recognized sensor units is sent to the mobile terminal 2 (see FIG. 2). Note that when the camera 15a (see FIG. 2) of the STB 1 is used, the camera 15a is set as enabled, and the light around the STB 1 is detected, thus creating a state in which an image signal can be acquired.

Here, in cases where none of the camera, gyro sensor, and microphone are in use, used sensor unit information to the effect that none of the sensor units 26 (camera 26a, gyro sensor 26b, and microphone 26c; see FIG. 2) of the mobile terminal 2 are used is sent to the mobile terminal 2. Moreover, for the sensor units 26 that are not used, the control unit 10 also sends a command signal to the effect of disabling the operation of those sensor units 26 so as to be included in the used sensor unit information.

In addition, in Step S41 on the side of the mobile terminal 2, the control unit 20 (see FIG. 2) of the mobile terminal 2 determines whether or not the used sensor unit information has been received. If it is determined that the used sensor unit information has not been received, the process advances to Step S45. If it is determined that the used sensor unit information has been received, then in Step S42, based on the used sensor unit information, the control unit 20 sets the operation of the sensor units 26 in use to enabled, and also in Step S43, information on the sensor units 26 set to enabled is recorded in the memory unit 27 (see FIG. 2).

This creates a state in which terminal-side detection signals can be acquired from the sensor units 26 set to enabled. When the use of the camera 26a is enabled, a state is created in which the light around the mobile terminal 2 is detected, and the image signal can be acquired. Note that when the use of the camera 26a is enabled, the camera 15a of the STB 1 is also simultaneously enabled. Furthermore, when the use of the gyro sensor 26b is enabled, a state is created in which the tilt of the mobile terminal 2 is detected, and the tilt signal can be acquired. Moreover, when the use of the microphone 26c is enabled, a state is created in which the sound around the mobile terminal 2 is detected (recorded), and the audio signal can be acquired.

On the other hand, in Step S44, based on the used sensor unit information, the control unit 20 halts the operation of the unused sensor units 26 by setting them to disabled. Consequently, no terminal-side detection signals are acquired from the sensor units 26 set to disabled.

Then, in Step S45, the control unit 20 determines whether or not the terminal-side detection signals (image signals, tilt signals, or audio signals) have been received from the sensor units 26 set to enabled. If it is determined that no terminal-side detection signals have been received, the process advances to Step S47. If it is determined that the terminal-side detection signals have been received, then in Step S46, the control unit 20 sends the terminal-side detection signals to the STB 1 “as is” without converting to control action information corresponding to some sort of control action upon the STB 1. Note that because no terminal-side detection signals will be acquired from the sensor units 26 set to disabled, the control unit 20 does not send to the STB 1 any terminal-side detection signals from the sensor units 26 set to disabled.

In addition, in Step S32 on the side of the STB 1, the control unit 10 determines whether or not the terminal-side detection signals from the mobile terminal 2 have been received or whether or not image signals from the camera 15a of the STB 1 have been received. If it is determined that no terminal-side detection signals or image signals (detection signals) from the camera 15a have been received, then in Step S33, the control unit 10 determines whether or not control actions from the user 4 (see FIG. 1) have been received at the controller unit 14 (see FIG. 2). If it is determined that no control actions have been received at the controller unit 14, the process advances to Step S35.

Furthermore, if it is determined in Step S32 that detection signals were received, or if it is determined in Step S33 that control actions were received at the controller unit 14, then in Step S34, the control unit 10 applies the control actions to the OS or application based on the terminal-side detection signals from the sensor units 26 set to enabled, image signals from the camera 15a set to enabled, and the control actions at the controller unit 14. As a result, the control unit 10 of the STB 1 performs actuation control corresponding to the OS or application on the STB 1 based on the terminal-side detection signals and image signals.

For example, in a case in which a car racing game application that uses the gyro sensor 26b is being executed on the STB 1, the gyro sensor 26b of the mobile terminal 2 is set to enabled based on the used sensor unit information, and the tilt signals detected by the gyro sensor 26b are sent “as is” to the STB 1 from the mobile terminal 2. Then, based on the tilt signals, the control unit 10 performs actuation control corresponding to the specified control actions on the STB 1 in the car racing game application. In concrete terms, as is shown in FIG. 1, the images of cars displayed within the game screen 3a of the display device 3 will be displayed so as to change direction corresponding to the tilt of the mobile terminal 2. This makes it possible, by adapting the gyro sensor 26b of the mobile terminal 2, to execute a car racing game application that cannot be executed with only the STB 1 which does not have a gyro sensor.

Moreover, in a case in which an application that uses the cameras 15a and 26a is executed in the STB 1, for example, both the camera 15a of the STB 1 and the camera 26a of the mobile terminal 2 will be set to enabled based on the used sensor unit information. Then, the image signals from the camera 15a will be received, and also the image signals from the camera 26a will be sent from the mobile terminal 2 “as is” to the STB 1. Thereafter, based on the image signals from the camera 15a and the image signals from the camera 26a, the control unit 10 will perform actuation control corresponding to the specified control actions on the STB 1 in the application.

Then, in Step S35, the control unit 10 determines whether or not the OS or application being executed in the STB 1 has been changed to a different OS or application. If it is determined that no change to a different OS or application has been made, the process advances to Step S37.

If it is determined that a change to a different OS or application has been made, then in Step S36, the sensor units used in the changed OS or application is recognized anew by the control unit 10 based on the integrated sensor unit information 16b. Then, the used sensor unit information related to the newly recognized sensor units is again sent to the mobile terminal 2. As a result, based on the used sensor unit information related to the newly recognized sensor units, the control unit 20 of the mobile terminal 2 drives the actuation of the sensor units 26 being used by setting them to enabled, but on the other hand, halts the actuation of the unused sensor units 26 by setting them to disabled. Then, the process advances to Step S37.

In addition, in Step S47 on the side of the mobile terminal 2, the control unit 20 determines whether or not the device control application has terminated on the mobile terminal 2. If it is determined that the device control application has not terminated, the process returns to Step S41. If it is determined that the device control application has terminated, then in Step S48, the control unit 20 transmits to the STB 1 a cutoff signal to provide notification that the state of connection between the STB 1 and the mobile terminal 2 will be cut off (disconnected). This terminates the flow of control processing of the mobile terminal 2 at the time of control actions.

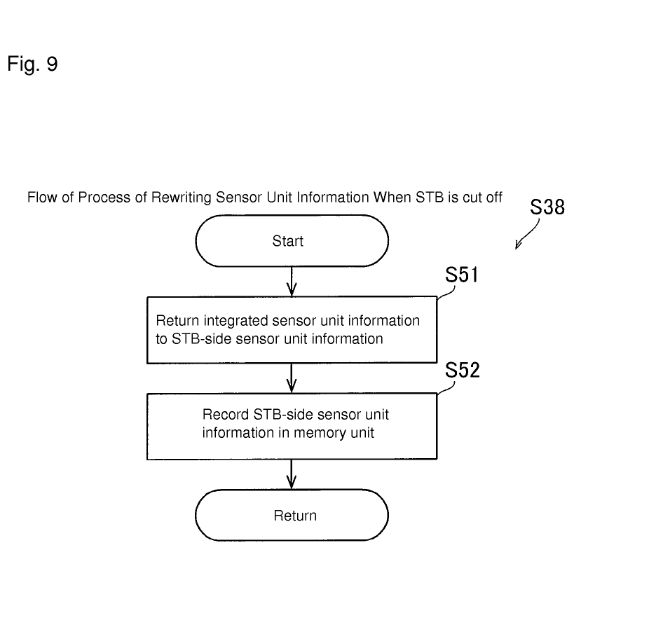

Furthermore, in Step S37 on the side of the STB 1, the control unit 10 determines whether or not a cutoff signal has been received from the mobile terminal 2. If it is determined that no cutoff signal has been received, the process returns to Step S32. If it is determined that a cutoff signal was received, the process moves to Step S38. In Step S38, the control unit 10 performs the process of rewriting the sensor unit information at the time of a disconnection (cutoff) shown in FIG. 9.

In this process of rewriting the sensor unit information in Step S38, first in Step S51, the control unit 10 returns the created integrated sensor unit information 16b to the STB-side sensor unit information 16a (see FIG. 3) as shown in FIG. 9. The integrated sensor unit information 16b to the effect that a camera, a gyro sensor, and a microphone are present as the sensor units that can be used in control actions on the STB 1 is returned to STB sensor unit information to the effect that it has a camera. Thereafter, in Step S52, the STB sensor unit information is recorded in memory unit 16 by the control unit 10. This completes the process of rewriting the sensor unit information at the time of a cutoff (Step S38), and completes the flow of control processing of the STB 1 at the time of control actions (see FIG. 8).

In the first preferred embodiment, as was described above, the control unit 10 of the STB 1 creates integrated sensor unit information 16b from the terminal-side sensor unit information 27a and the STB-side sensor unit information 16a and recognizes the sensor units 26 of the mobile terminal 2 and the sensor unit 15 of the STB 1, and also, based on terminal-side detection signals from the sensor units 26 that were set to enabled, image signals from the camera 15a that were set to enabled, and control actions at the controller unit 14, performs actuation control corresponding to the OS or application being executed on the STB 1. By having such a constitution, the control unit 10 of the STB 1 recognizes in advance the terminal-side detection signals of the sensor units 26 in the mobile terminal 2, which makes it possible for the control unit 10 to correctly identify the content of the terminal-side detection signals transmitted from the mobile terminal 2 and to perform the actuation control of the STB 1 corresponding to specified control actions. As a result, it is possible to control the STB based on the terminal-side detection signals of the mobile terminal 2 including the sensor units 26 without using any dedicated remote control device. Moreover, the control unit 10 of the STB 1 recognizes not only the sensor units 26 of the mobile terminal 2, but also the camera 15a of the STB 1, so actuation control can be performed on the STB 1 based on more detection signals (including the image signals and not just the terminal-side detection signals) than in the case when only the sensor units 26 of the mobile terminal 2 are recognized.

In addition, in the first preferred embodiment, as was described above, the control unit 20 of the mobile terminal 2 sends the terminal-side detection signals (image signals, tilt signals, or audio signals) to the STB 1 from the sensor units 26 (camera 26a, gyro sensor 26b, and microphone 26c) that are set to enabled, and the control unit 10 of the STB 1 uses the terminal-side detection signals from the mobile terminal 2 to control the OS or application. If such a constitution is used, it is possible to add the function of performing specified control actions on the STB 1 using the camera 26a, gyro sensor 26b, and microphone 26c to a mobile terminal 2 that can also be used alone. Therefore, the control system for the STB 1 using the camera 26a, gyro sensor 26b, and microphone 26c can be easily constructed using a universal (general-use) mobile terminal 2.

Furthermore, in the first preferred embodiment, as was described above, sensor unit information for the purpose of having the control unit 20 of the mobile terminal 2 determine that terminal-side detection signals from those sensor units 26 set to enabled is to be sent to the STB 1, while terminal-side detection signals from those sensor units 26 set to disabled are not to be sent to the STB 1 is sent by the control unit 10 of the STB 1 to the mobile terminal 2. As a result of such a constitution being adopted, only those terminal-side detection signals required for the control of the STB 1 will be sent from the mobile terminal 2 to the STB 1, so it is possible to keep the amount of communications traffic between the mobile terminal 2 and the STB 1 from increasing.

Moreover, in the first preferred embodiment, as was described above, the control unit 10 also sends a command signal to the effect of disabling the operation of those sensor units 26 that are set to disabled so as to be included in the used sensor unit information, so those sensor units 26 that are unnecessary for the control of the STB 1 are disabled, which makes it possible to halt the operation of unnecessary sensor units 26. Consequently, in battery-driven mobile terminals 2 where increased power consumption is a major problem, it is possible to keep the power consumption from increasing.

In addition, in the first preferred embodiment, as was described above, as a result of the terminal-side sensor unit information 27a having the record in the form of a list that the mobile terminal 2 includes the camera 26a, gyro sensor 26b, and microphone 26c, it is possible for the control unit 10 of the STB 1 to easily recognize in advance the sensor units 26 based on the terminal-side sensor unit information 27a which includes information in the form of the list of a plurality of sensor units 26.

In the first preferred embodiment, furthermore, as was described above, in a case in which an application that uses the cameras 15a and 26a is executed in the STB 1, both the camera 15a of the STB 1 and the camera 26a of the mobile terminal 2 will be set to enabled based on the used sensor unit information, and the image signals will be received from the camera 15a, and also the image signals detected by the camera 26a will be sent “as is” from the mobile terminal 2 to the STB 1. Then, based on the image signals from the camera 15a and the image signals from the camera 26a, the control unit 10 will perform actuation control corresponding to the specified control actions on the STB 1 in the application. Having such a constitution allows the user 4 to perform specified control actions on the STB 1 by using both the mobile terminal 2 and the STB 1, so the user 4 can use either the mobile terminal 2 or the STB 1, whichever is easier to control, to perform specified control actions on the STB 1. Thereby, the control system 100 can be made more convenient.

Moreover, in the first preferred embodiment, as was described above, the control unit 20 sends the terminal-side detection signals “as is” to the STB 1 without converting to control action information corresponding to some sort of control action upon the STB 1, so there is no need to have the mobile terminal 2 recognize the content of control actions on the STB 1 corresponding to the terminal-side detection signals, and this can therefore reduce the volume of data in the device control application and also lessen the burden of control upon the control unit 20.

In addition, in the first preferred embodiment, while the mobile terminal 2 is preferably provided with the gyro sensor 26b and microphone 26c, the STB 1 preferably is not provided with any gyro sensor or microphone, and this make it possible to eliminate the need to limit the installation location of the STB 1 to the vicinity of the user 4 in order to allow the user 4 to use the gyro sensor or microphone of the STB 1. Furthermore, because the STB 1 is not provided with any gyro sensor or microphone, this prevents an increase in the size of the STB 1.

### Second Preferred Embodiment

Next, a second preferred embodiment of the present invention will be described with reference to FIGS. 1 through 6, 8, and 10 through 13. In this second preferred embodiment, unlike the first preferred embodiment, a description will be given of a case in which the user 4 is allowed to choose whether or not rewriting of the sensor unit information of the STB 1 is to be performed. Note that in the second preferred embodiment, other than the process of rewriting the sensor unit information at the time of connection in Step S14a and the process of rewriting the sensor unit information at the time of disconnection (cut off) in Step S38a, the procedures preferably are the same as in the first preferred embodiment, so the description thereof will be omitted.

First, the process of rewriting the sensor unit information at the time of connection in the second preferred embodiment of the present invention will be described with reference to FIGS. 1 through 6, 10, and 11.

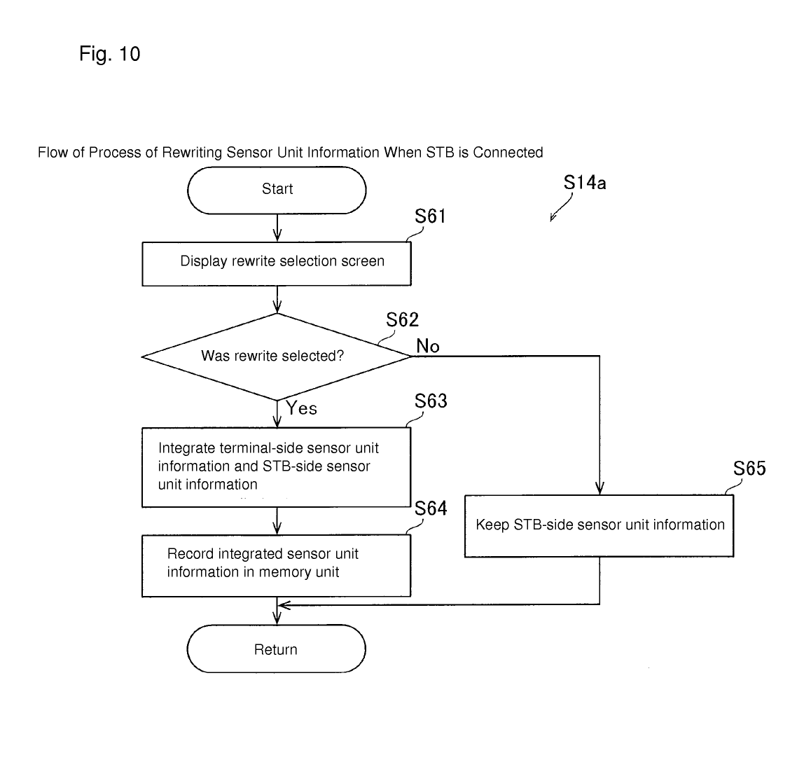

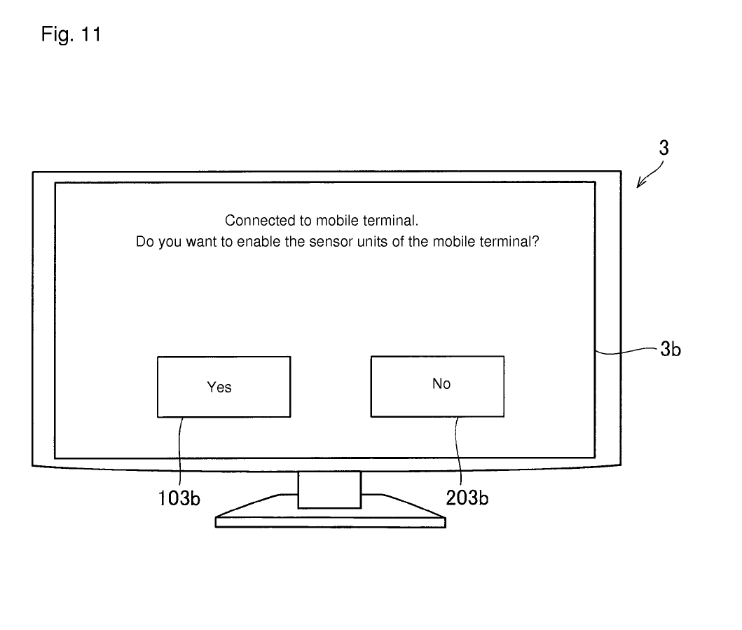

In the second preferred embodiment, as is shown in FIG. 10, in the process of rewriting the sensor unit information (see FIG. 6) in Step S14a, first in Step S61, the control unit 10 (see FIG. 2) of the STB 1 (see FIG. 2) displays on the display device 3 (see FIG. 11) a rewrite selection screen 3b (see FIG. 11) for having the user 4 (see FIG. 1) select whether or not to integrate the terminal-side sensor unit information 27a (see FIG. 4) received from the mobile terminal 2 (see FIG. 2) and the STB-side sensor unit information 16a (see FIG. 3) of the memory unit (see FIG. 2). As is shown in FIG. 11, on this rewrite selection screen 3b, a message asking whether or not to enable the sensor units 26 (see FIG. 2) of the mobile terminal 2, along with a selection part 103b labeled “Yes” and a selection part 203b labeled “No”, are displayed. On the rewrite selection screen 3b, furthermore, either the selection part 103b or the selection part 203b is selected by the user 4 controlling the controller unit 14 (see FIG. 2).

Then, in Step S62, the control unit 10 determines whether or not the selection part 103b (see FIG. 11) was selected so that rewrite was selected as shown in FIG. 10. If it is determined that rewrite was selected, the same control processes as in Step S21 and Step S22 in the first preferred embodiment are performed in Step S63 and Step S64, respectively. In Step S63, the control unit 10 creates the integrated sensor unit information 16b (see FIG. 5), and the integrated sensor unit information 16b thus created is recorded in the memory unit in Step S64. This terminates the process of rewriting the sensor unit information at the time of connection (Step S14a), and the flow of control processing of the STB 1 at the time of connection is terminated.

As a result, if the user 4 makes the selection to rewrite, the control unit 10 of the STB 1 creates the integrated sensor unit information 16b from the terminal-side sensor unit information 27a and the STB-side sensor unit information 16a and recognizes the sensor units 26 of the mobile terminal 2 and the camera 15a of the STB 1. Then, based on the terminal-side detection signals from the sensor units 26 that were set to enabled, image signals from the camera 15a that was set to enabled, and control actions at the controller unit 14, the control unit 10 of the STB 1 performs actuation control corresponding to the OS or application on the STB 1.

Alternatively, if it is determined in Step S62 that rewrite was not selected as a result of the selection part 203b (see FIG. 11) being selected, then in Step S65, the control unit does not create the integrated sensor unit information 16b but rather keeps the STB-side sensor unit information 16a. This terminates the process of rewriting the sensor unit information at the time of connection, and the flow of control processing of the STB 1 at the time of connection is terminated.

Next, with reference to FIGS. 1 through 6, 8, and 11 through 13, a description will be given of the process of rewriting the sensor unit information at the time of cut off in the second preferred embodiment of the present invention.

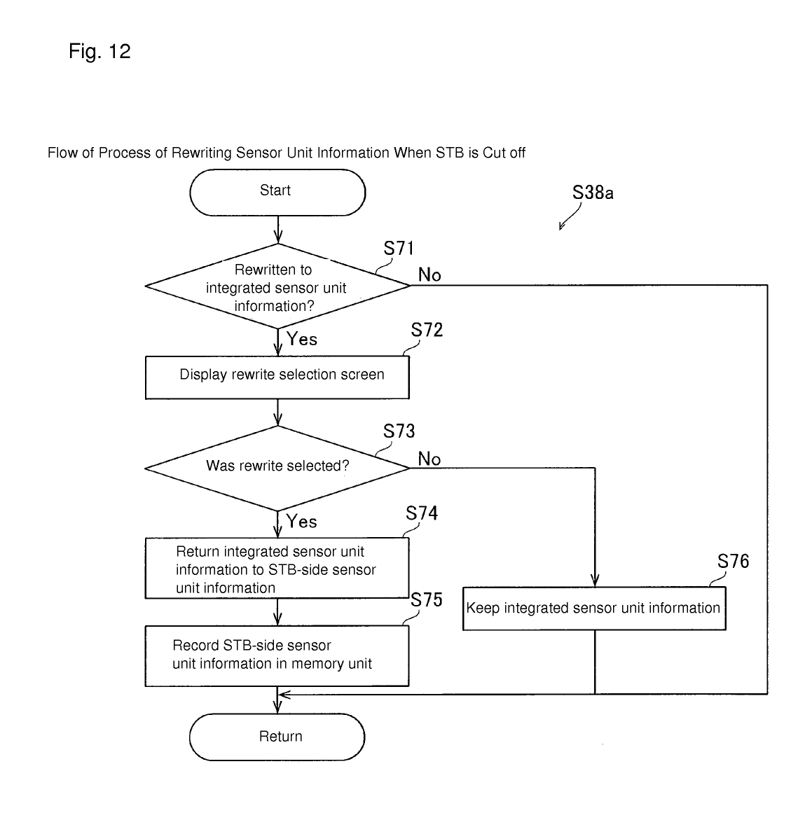

In the second preferred embodiment, in the process of rewriting the sensor unit information in Step S38a (see FIG. 8), as shown in FIG. 12, first in Step S71, the control unit 10 (see FIG. 2) of the STB 1 (see FIG. 2) determines whether or not the integrated sensor unit information 16b (see FIG. 5) had been created in the process of rewriting the sensor unit information at the time of connection (see FIG. 11) and recorded in the memory unit 16 (see FIG. 5). If it is determined that the integrated sensor unit information 16b was not created (the STB-side sensor unit information 16a (see FIG. 3) is recorded in the memory unit 16), there is no need to perform a control process that deletes the integrated sensor unit information 16b, so the process of rewriting the sensor unit information at the time of cutoff is terminated, and the flow of control processing of the STB 1 at the time of control actions is terminated.

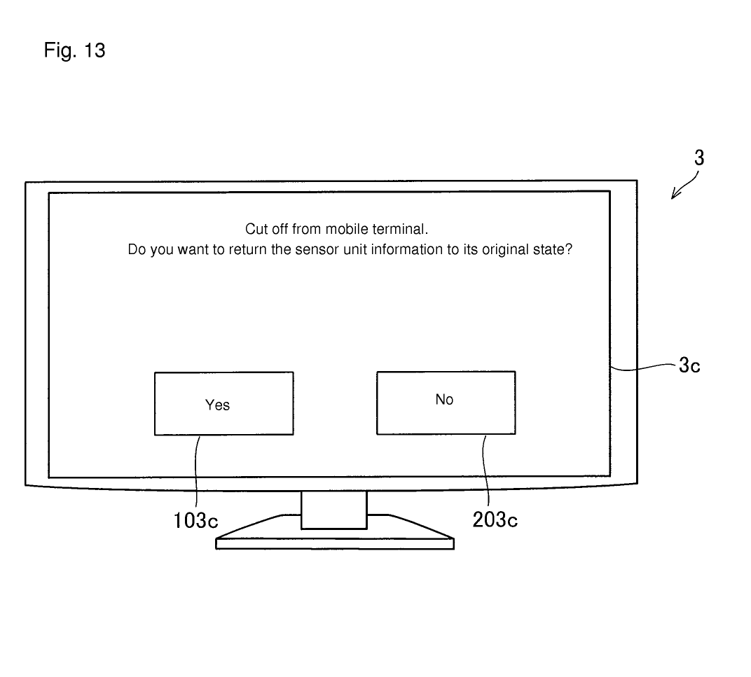

On the other hand, if it is determined that the integrated sensor unit information 16b was created, then in Step S72, the control unit 10 displays on the display device 3 a rewrite selection screen 3c for having the user 4 (see FIG. 1) select whether or not to return the integrated sensor unit information 16b to the STB-side sensor unit information 16a as shown in FIG. 13. On this rewrite selection screen 3c are displayed a message asking whether or not to return from the integrated sensor unit information 16b to the STB-side sensor unit information 16a, along with a selection part 103c labeled “Yes” and a selection part 203c labeled “No.” Then, on the rewrite selection screen 3c, either the selection part 103c or the selection part 203c is selected as a result of the user 4 operating the controller unit 14 (see FIG. 2).

Then, as is shown in FIG. 12, the control unit 10 determines in Step S73 whether or not the selection part 103c (see FIG. 13) was selected so that rewrite was selected. If it is determined that rewrite was selected, the same control processes as in Step S51 and Step S52 in the first preferred embodiment are performed in Step S74 and Step S75, respectively. That is, in Step S74, the control unit 10 returns from the integrated sensor unit information 16b to the STB-side sensor unit information 16a, and the STB-side sensor unit information 16a is recorded in the memory unit 16 in Step S75. This terminates the process of rewriting the sensor unit information at the time of cutoff (Step S38a) is terminated, and the flow of control processing of the STB 1 at the time of control action is terminated.

Alternatively, if it is determined in Step S73 that rewrite was not selected as a result of the selection part 203c (see FIG. 13) being selected, then in Step S76, the control unit does not delete the integrated sensor unit information 16b from the memory unit 16 but rather keeps it. Consequently, even if the server 6 is constituted such that devices that do not have the corresponding sensor unit are not permitted to acquire an application, and even in a state in which the STB 1 and the mobile terminal 2 are not connected, it becomes possible to acquire (download) from the server 6 an application that cannot be controlled by only the sensor unit 15 of the STB 1, based on the integrated sensor unit information 16b which has the record that there are the sensor units 26 of the mobile terminal 2. Afterwards, the process of rewriting the sensor unit information at the time of cutoff is terminated, and the flow of control processing of the STB 1 at the time of control action is terminated.

In the second preferred embodiment, as was described above, if rewriting is selected by the user 4, the control unit 10 of the STB 1 creates the integrated sensor unit information 16b and also performs actuation control corresponding to the OS or application based on the terminal-side detection signals from those sensor units 26 set to be enabled. Having such a constitution allows the STB 1 to be controlled based on the terminal-side detection signals of the mobile terminal 2 having the sensor units 26 without using any dedicated remote control.

In the second preferred embodiment, furthermore, as was described above, if rewriting is not selected, the control unit 10 does not delete the integrated sensor unit information 16b from the memory unit 16 but rather keeps it, which eliminates the need to recreate anew the integrated sensor unit information 16b when the STB 1 and the mobile terminal 2 are reconnected, so it is possible to start operation of the control system 100 more quickly.

Moreover, in the second preferred embodiment, as was described above, the control unit 10 does not delete the integrated sensor unit information 16b from the memory unit 16 but rather keeps it, so it becomes possible to acquire from the server 6 an application that cannot be controlled by only the sensor unit 15 of the STB 1, based on the integrated sensor unit information 16b which has the record that there are the sensor units 26 of the mobile terminal 2. Note that the other effects of the second preferred embodiment are the same as those of the first preferred embodiment.

### Third Preferred Embodiment

Next, a third preferred embodiment of the present invention will be described with reference to FIGS. 1 through 4, 6, and 14 through 17. In this third preferred embodiment, in contrast to the first preferred embodiment, a case will be described in which the user 4 is allowed to select the sensor units that are to be enabled when there is commonality between the sensor unit 15 of the STB 1 and the sensor units 26 of the mobile terminal 2. Note that the third preferred embodiment is the same as the first preferred embodiment other than in the process of rewriting the sensor unit information at the time of connection in Step S14b, so an explanation thereof is omitted.

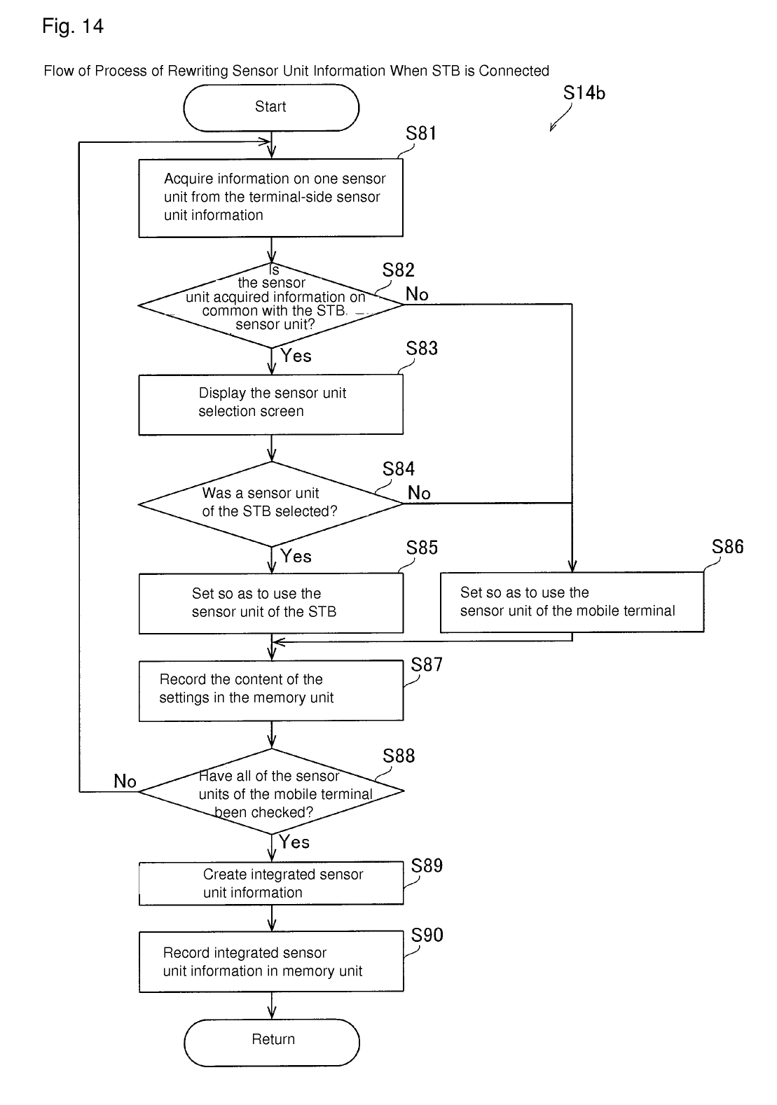

In the third preferred embodiment, in the process of rewriting the sensor unit information in Step S14b (see FIG. 6), first in Step S81, the control unit 10 (see FIG. 2) of the STB 1 (see FIG. 2) acquires information on one sensor unit 26 (see FIG. 2) among the camera 26a, the gyro sensor 26b, and the microphone 26c from the terminal-side sensor unit information 27a (see FIG. 4) received from the mobile terminal 2 (see FIG. 2) as shown in FIG. 14. Then, in Step S82, the control unit 10 determines whether or not there is commonality between the sensor unit 26 of the mobile terminal 2 for which information was acquired and the sensor unit 15 (camera 15a) of the STB 1.

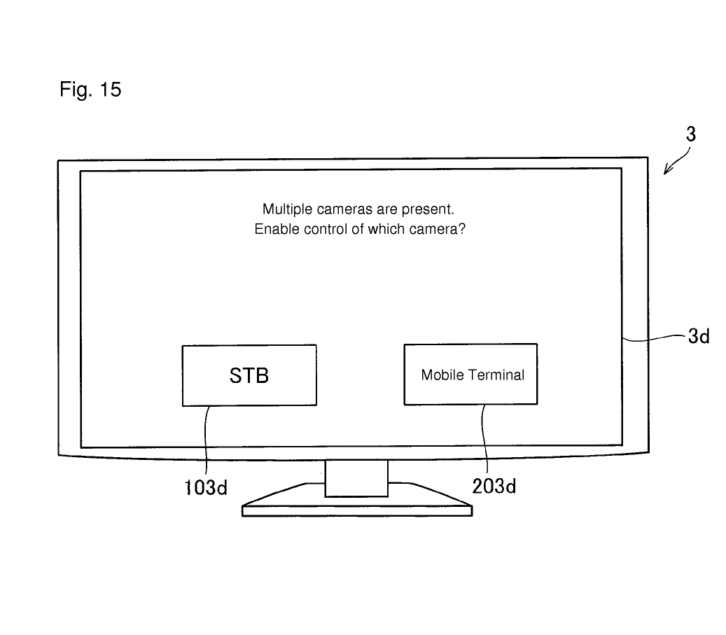

If it is determined that there is commonality between the sensor unit 26 of the mobile terminal 2 and the camera 15a of the STB 1 (if the sensor unit 26 is the camera 26a), then in Step S83, the control unit 10 displays on the display device 3 a sensor unit selection screen 3d for having the user 4 (see FIG. 1) select which camera is to be used between the camera 15a of the STB 1 and the camera 26a of the mobile terminal 2 as shown in FIG. 15. On this sensor unit selection screen 3d are displayed a message asking which camera is to be used between the camera 15a of the STB 1 and the camera 26a of the mobile terminal 2, along with a selection part 103d labeled “STB” and a selection part 203d labeled “Mobile Terminal.” Then, on the sensor unit selection screen 3d, either the selection part 103d or the selection part 203d is selected as a result of the user 4 operating the controller unit 14 (see FIG. 2).

Then, in Step S84, the control unit 10 determines whether or not the user 4 had selected to use the camera 15a of the STB 1 between the camera 15a of the STB 1 and the camera 26a of the mobile terminal 2 as shown in FIG. 14. If it is determined that the camera 15a of the STB 1 was selected due to the selection part 103d (see FIG. 15) being selected, then in Step S85, the control unit 10 is set to use the camera 15a of the STB 1.

On the other hand, if it is determined in Step S82 that there is no commonality between the sensor unit 26 of the mobile terminal 2 and the camera 15a of the STB 1 (if the sensor unit 26 is the gyro sensor 26b or the microphone 26c), or if the camera 26a of the mobile terminal 2 is selected for use due to the selection part 203d (see FIG. 15) being selected in Step S84, then in Step S86, the control unit 10 is set to use the camera 26a of the mobile terminal 2.

Moreover, in Step S87, the content of the setting is recorded in memory unit 16 (see FIG. 2) by the control unit 10. Thereafter, in Step S88, the control unit 10 determines whether or not all of the sensor units 26 of the mobile terminal 2 have been checked for commonality with the camera 15a of the STB 1. If it is determined that not all of the sensor units 26 of the mobile terminal 2 have been checked, the process returns to Step S81, and checking is performed on another sensor unit 26.

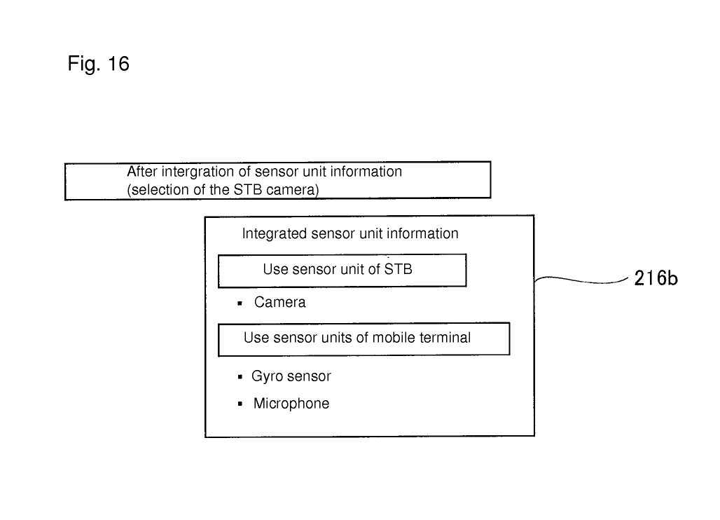

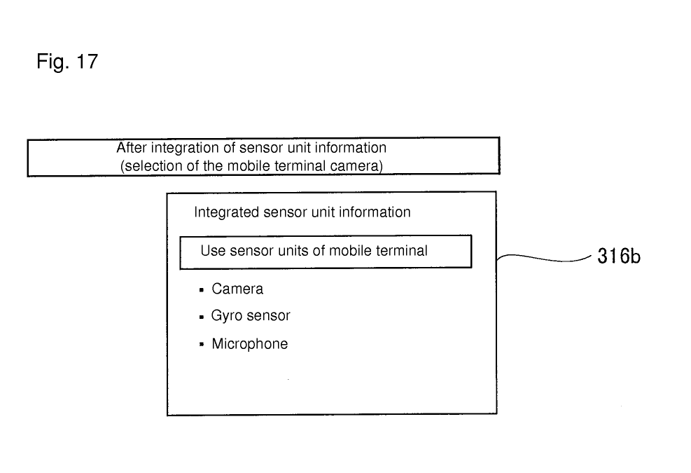

If it is determined that all of the sensor units 26 of the mobile terminal 2 have been checked, then in Step S89, the control unit 10 creates either integrated sensor unit information 216b (see FIG. 16) or integrated sensor unit information 316b (see FIG. 17) based on the content of settings recorded in the memory unit 16 and the STB-side sensor unit information 16a (see FIG. 3). Afterwards, in Step S90, the integrated sensor unit information 216b or 316b thus created is recorded in the memory unit 16. Then, the process of rewriting the sensor unit information at the time of connection (Step S14b) is terminated, and the flow of control processing of the STB 1 at the time of connection is terminated.

As a result, if the camera 15a of the STB 1 is determined to have been selected, the integrated sensor unit information 216b is created so as to use the camera 15a of the STB 1 and the gyro sensor 26b or microphone 26c of the mobile terminal 2, but not use the camera 26a of the mobile terminal 2 as shown in FIG. 16. Alternatively, if the camera 26a of the mobile terminal 2 is determined to have been selected, the integrated sensor unit information 316b is created so as to use the camera 26a and the gyro sensor 26b or microphone 26c of the mobile terminal 2, but not use the camera 15a of the STB 1 as shown in FIG. 17.

As a result, the control unit 10 of the STB 1 creates integrated sensor unit information 216b or 316b from the terminal-side sensor unit information 27a and the selection of the user 4, thus recognizing the sensor unit 26 of the mobile terminal 2 and the sensor unit 15 of the STB 1. Furthermore, the control unit 10 of the STB 1 performs actuation control on the STB 1 corresponding to the OS or application based on the terminal-side detection signal from the sensor unit 26 set to enabled, the image signal from the camera 15a set to enabled, and the control action at the controller unit 14.

In the third preferred embodiment, as was described above, the control unit 10 of the STB 1 creates the integrated sensor unit information 16b from the terminal-side sensor unit information 27a, the STB-side sensor unit information 16a, and the selection of the user 4, and also performs actuation control corresponding to the OS or application based on the terminal-side detection signal from the sensor unit 26 set to enabled and on other factors. With such a constitution, it is possible to control the STB 1 based on the terminal-side detection signals of the mobile terminal 2 including the sensor units 26 without using any dedicated remote control device.

In addition, as was described above, the third preferred embodiment is constituted such that if it is determined that there is commonality between the camera 26a of the mobile terminal 2 and the camera 15a of the STB 1, the control unit 10 allows the user 4 to select which of the cameras is to be used between the camera 15a of the STB 1 and the camera 26a of the mobile terminal 2. If such a constitution is adopted, the detection signals of the sensor unit not selected by the user 4 are not used, so it is possible to prevent output of detection signals from the sensor unit not selected by the user 4. This makes it possible to prevent control actions not intended by the user 4 from being performed upon the STB 1. Note that the other effects of the third preferred embodiment are the same as those of the first preferred embodiment.

Note that the preferred embodiments disclosed herein merely constitute illustrative examples in all respects and should be considered to be nonrestrictive. The scope of the present invention is indicated not by the description of the preferred embodiments but rather by the scope of the claims, and includes all modifications with an equivalent meaning to the scope of the claims and within the scope of the claims.

For instance, in the first through third preferred embodiments, a non-limiting example was described in which the STB 1 preferably is equipped with a single sensor unit 15 (a camera 15a), while the mobile terminal 2 preferably is equipped with three sensor units 26 (a camera 26a, a gyro sensor 26b, and a microphone 26c), but the present invention is not limited to this. In the present invention, the number of the sensor units provided in the STB may be two or more, and the number of the sensor units provided in the mobile terminal may be one, two, or four or more. Furthermore, the STB does not have to be provided with any sensor unit.

Moreover, in the first through third preferred embodiments, an example was described in which preferably there is commonality in the type of both the sensor unit 15 of the STB 1 and the sensor unit 26 of the mobile terminal 2 as the cameras 15a and 26a, but the present invention is not limited to this. In the present invention, there may not be commonality between the type of sensor unit of the STB and type of sensor unit of the mobile terminal. This makes it possible to present control actions not intended by the user from being performed on the STB due to the detection on the side of the sensor unit not controlled by the user. In addition, the type of sensor unit of the STB and the type of sensor unit of the mobile terminal may be in common by two or more types, and the type of sensor unit other than a camera may also be in common.

Furthermore, in the first through third preferred embodiments, an example was described in which the mobile terminal 2 preferably includes a camera 26a, a gyro sensor 26b, and a microphone 26c as the sensor units 26, but the present invention is not limited to this. For example, a touch panel, illumination sensor, temperature sensor, GPC (global positioning system), RFID (radio frequency identification) tag, and other sensor units may also be provided in the STB or in the mobile terminal.

Moreover, in the second preferred embodiment, an example was described in which at the time of both connection and disconnection (cutoff), the user 4 is preferably allowed to select whether or not rewriting of the sensor unit information of the STB 1 is to be performed, but the present invention is not limited to this. In the present invention, it is also possible to allow the user to select whether or not rewriting of the sensor unit information of the STB is to be performed only either at the time of connection or at the time of cutoff.

In addition, in the first through third preferred embodiments, an example was described in which the STB 1 and the mobile terminal 2 preferably are wirelessly connected via the wireless router 5, but the present invention is not limited to this. In the present invention, the STB and the mobile terminal may also be connected by a method other than wireless connection. For instance, cable connection of the STB and the mobile terminal is also possible.

Furthermore, in the first through third preferred embodiments, an example was described in which the mobile terminal 2 preferably is provided with a 3G communication unit 21, but the present invention is not limited to this. In the present invention, the mobile terminal may also be provided with a communication unit other than the 3G communication unit.

Moreover, in the first through third preferred embodiments, for the purpose of illustration, the processing of the control unit 10 of the STB 1 and the processing of the control unit 20 of the mobile terminal 2 were described using flow-driven-type flowcharts in which processes are performed in order along the flow of the control processing, but the present invention is not limited to this. In the present invention, the processing of the control unit of the STB and the processing of the control unit of the mobile terminal may also be performed by event-driven type of processes in which processes are performed in event units. In this case, the processing may be performed completely by an event-driven-type or by a combination of even-driven and flow-driven types.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2: A control system for a video device comprising:
a mobile terminal which includes at least one terminal-side detector and a terminal-side communication unit to send terminal-side detector information pertaining to the terminal-side detector and a terminal-side detection signal detected by the terminal-side detector at a time of a specified control action; and
a video device which includes a control unit and a device-side communication unit to receive the terminal-side detector information and the terminal-side detection signal from the mobile terminal; wherein
the control unit of the video device is constituted and programmed to recognize the terminal-side detector from the terminal-side detector information and also perform actuation control corresponding to a specified control action on the video device based on the terminal-side detection signal of the recognized terminal-side detector.

3: The control system for a video device according to claim 2, wherein
the terminal-side detector is provided to satisfy specified functions when the mobile terminal is used alone; and
the control unit of the video device is constituted and programmed to adapt the terminal-side detector that is used to satisfy the specified functions of the mobile terminal for the actuation control corresponding to the specified control action on the video device.

4: The control system for a video device according to claim 3, wherein
the mobile terminal includes, as the terminal-side detector to satisfy the specified functions of the mobile terminal, at least one of an image-capture unit that captures images, a gyro sensor that detects an attitude of the mobile terminal, and a microphone enabling conducting of conversations; and
the control unit of the video device is constituted and programmed to use at least one of the image-capture unit, the gyro sensor, and the microphone of the mobile terminal to perform actuation control corresponding to the specified control action on the video device.

5: The control system for a video device according to claim 2, wherein
the mobile terminal includes a plurality of the terminal-side detectors; and
the control unit of the video device is constituted and programmed to recognize terminal-side detectors required for the control of the video device from among the plurality of terminal-side detectors based on the terminal-side detector information and also to exert control to have the device-side communication unit send a signal which causes the terminal-side communication unit to send the terminal-side detection signals of those of the terminal-side detectors required for the control of the video device but causes the terminal-side communication unit not to send the terminal-side detection signals of those of the terminal-side detectors not required for the control of the video device.

6: The control system for a video device according to claim 5, wherein the control unit of the video device is constituted and programmed to exert control to have the device-side communication unit send a signal to disable operation of the terminal-side detectors not required for the control of the video device.

7: The control system for a video device according to claim 2, wherein
the mobile terminal includes a plurality of the terminal-side detectors; and
the terminal-side detector information pertaining to the plurality of terminal-side detectors includes information in a form of a list of the plurality of terminal-side detectors.

8: The control system for a video device according to claim 2, wherein
the video device further comprises at least one device-side detector; and
the control unit of the video device is constituted and programmed to create integrated detector information by integrating device-side detector information pertaining to the device-side detector and the terminal-side detector information, recognize the device-side detector and at least one of the terminal-side detectors from the integrated detector information thus created, and perform actuation control corresponding to the specified control action on the video device based on a device-side detection signal detected by at least one of the recognized device-side detector and the terminal-side detection signals of the recognized terminal-side detector.

9: The control system for a video device according to claim 8, wherein the control unit of the video device is constituted and programmed such that if the control unit determines from the integrated detector information that there is commonality between a type of the device-side detector and a type of the terminal-side detector, the control unit is programmed to perform actuation control corresponding to the specified control action on the video device based on both the device-side detection signals of the device-side detector and the terminal-side detection signals of the terminal-side detector.

10: The control system for a video device according to claim 8, wherein the control unit of the video device is constituted and programmed such that if the control unit determines from the integrated detector information that there is commonality between a type of the device-side detector and a type of the terminal-side detector, the control unit is programmed to perform actuation control corresponding to the specified control action on the video device based on either the device-side detection signals of the device-side detector or the terminal-side detection signals of the terminal-side detectors, whichever is selected by the user.

11: The control system for a video device according to claim 8, wherein
the video device further comprises a recording unit that records the integrated detector information; and
the control unit of the video device is constituted so as to be able to maintain the created integrated detector information without deleting it from the recording unit when the video device and the mobile terminal are disconnected.

12: A video device which can be controlled by a mobile terminal, comprising:
a device-side communication unit that receives, from the mobile terminal, terminal-side detector information pertaining to at least one terminal-side detector included in the mobile terminal and terminal-side detection signals detected by the terminal-side detector at a time of a specified control action on the video device; and
a control unit programmed to recognize the terminal-side detector from the terminal-side detector information and to perform actuation control corresponding to the specified control action on the video device based on the terminal-side detection signals of the recognized terminal-side detector.
